(19) United States
(12) Patent Application Publication
(10) Pub. No.: US 2013/0337407 A1
(43) Pub. Date: Dec. 19, 2013

(54) REAMER ROOT CANAL INSTRUMENT

(71) Applicants: Julien Mordeniz, Besancon (FR); Rashid El Abed, Dubai (AE)

(72) Inventors: Julien Mordeniz, Besancon (FR); Rashid El Abed, Dubai (AE)

(73) Assignee: MICRO MEGA INTERNATIONAL MANUFACTURES, Besancon (FR)

(21) Appl. No.: 14/001,595

(22) PCT Filed: Feb. 24, 2012
(86) PCT No.: PCT/FR12/50394

§ 371 Date: Aug. 26, 2013

(30) Foreign Application Priority Data
Feb. 25, 2011 (FR) 11 51525

(51) Int. Cl. A61C 5/02

(52) U.S. Cl. CPC A61C 5/023
USPC 433/102; 409/131

(57) ABSTRACT

A dental reamer root canal instrument has a working area that is substantially cylindrical or conical along a longitudinal axis, the instrument including X helical flutes forming X lips of helical cuts, a cut lip being formed by the intersection of two consecutive flutes, wherein X is equal to or greater than three. Over a cross-section of the instrument, the angles (αI, βI, γI) between two consecutive cut lips, measured relative to the longitudinal axis of the instrument, are all different. A method for producing the root canal instrument in a cylindrical or conical rod is also disclosed. The rod is made of a metal or metal alloy material selected for the mechanical bending strength and shape memory properties thereof. The method includes steps for using a grinding wheel to machine a flute to a predefined depth and steps for rotating the rod in front of the machining wheel.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a root canal instrument of the dental reamer type, having a substantially cylindrical or conical working area along a longitudinal axis, the instrument comprising X helical flutes, forming X helical cutting lips, each cutting lip being formed by the intersection of two successive flutes. Instruments of this type are used in endodontics for the preparation of root canals.

2. Description of Related Art Including Information Disclosed Under 37 CFR 1.91 and 37 CFR 1.98.

EP0801930 describes a reamer of this type comprising three cutting lips whose vertices form the vertices of an equilateral triangle. This type of instrument is satisfactory unless the canal to be prepared has a non-circular cross section. Additionally, during its movement into the canal, the instrument tends to screw and engage in the walls of the canal, thereby damaging the walls of the canal and creating a risk of injury to the patient being treated. EP 1214013 describes a reamer comprising three cutting lips whose vertices form the vertices of an isosceles triangle. The asymmetrical cross section of this instrument makes it more effective when the cross section of the canal is not circular, but the instrument still tends to screw during its movement into the canal.

The problem of screwing is crucial for helical root canal instruments. This is because, owing to their design, these instruments have a natural tendency to screw, as a result of the presence of helical flutes. It is imperative to limit the risk of screwing as far as possible, to avoid injuring the patient and/or damaging the root canal.

### BRIEF SUMMARY OF THE INVENTION

The invention proposes a novel root canal instrument which is free from all or some of the drawbacks of the prior art instruments. More specifically, the invention proposes an instrument of the dental reamer type, having a substantially cylindrical or conical working area along a longitudinal axis of the instrument; the working area comprises X helical flutes, forming X helical cutting lips, each cutting lip being formed by the intersection of two successive flutes, where X is greater than or equal to three. According to the invention, in a cross section of the instrument, the angles between two successive cutting lips, measured with respect to the longitudinal axis of the instrument, are all different.

With these angles, the cross section has no axis of symmetry and no center of symmetry, and the degree of asymmetry of the cross section is further increased. By comparison with the prior art instruments, therefore, the degree of asymmetry of the cross section of the instrument is increased. Thus the possibilities of snaking of the instrument during its movement inside the canal are increased. The edges of the instrument do not contact the wall of the canal as the same time, and therefore do not cut the canal wall at the same time. The instrument penetrates into the canal more easily, and moves in a wavering manner, thus limiting the risks of screwing and the risks of engagement of the instrument.

In order to increase the degree of asymmetry of the cross section of the instrument still further, the angles between two successive cutting lips, measured with respect to the center of gravity of the cross section, may also all be different.

In a variant, the angles between two successive cutting lips, measured with respect to the longitudinal axis of the instrument or with respect to the center of gravity of the cross section, may be constant over a portion of the working area of the instrument. In another variant, the angles between two successive cutting lips, measured with respect to the longitudinal axis of the instrument or with respect to the center of gravity of the cross section, are variable over a portion of the working area of the instrument. In this case, a portion of the instrument may constitute the total length of the working area of the instrument or only a part of the working area of the instrument. By varying the angles between two lips, the degree of asymmetry of the instrument, and therefore its efficiency, are further increased.

In an instrument according to the invention, the cutting angles of the cutting lips may also be made so that they are all different. For a cutting lip, formed by the intersection of two successive flutes, the cutting angle is, in the plane of a cross section of the working area, the angle formed by the tangent of the flute located on the side of the cutting direction and a radius passing through the cutting edge and the axis of the instrument.

Thus an additional asymmetry is created by the way in which the cutting lips cut the canal wall, further limiting the risks of screwing and engagement of the instrument in the canal wall.

It is also possible to make all the helix angles different in the same cross section of the instrument, again with the aim of increasing the asymmetry. A helix angle is an angle between the longitudinal axis of the instrument and a tangent to a cutting lip, in the cross section in question.

It is also possible to position all the cutting lips on concentric circles centered on the longitudinal axis and all having different diameters. This configuration provides a small additional deformation in the cross section and further increases its asymmetry.

In a variant of the invention, the instrument comprises X=3 helical flutes. The vertices of the cutting lips thus form an irregular triangle. In another variant, the instrument comprises X=4 helical flutes, and the vertices of the cutting lips thus form an irregular quadrilateral. It is possible to make instruments comprising larger numbers of flutes, but the difficulty of making the instrument also increases with the number of flutes.

The invention also proposes a method for making a root canal instrument according to the invention from a cylindrical or conical rod. The rod is, for example, made of a metal or metal alloy chosen for its mechanical properties of bending resistance and shape memory notably, for example a nickel-titanium alloy. The method comprises a sequence of steps of machining by milling a flute to a predetermined depth, where the predetermined depths all differ from one machining step to another, and steps of rotation of the rod under the milling machine. For example, for making an instrument with three helical flutes, the method comprises:
a first machining of a helical flute along the longitudinal axis of the rod, to a first depth,
a rotation of the rod about the longitudinal axis of the instrument through a first angle,
a second machining of a helical flute along the longitudinal axis of the rod, to a second depth which is different from the first depth,
a rotation of the rod about the longitudinal axis of the instrument through a second angle,
a third machining of a helical flute along the longitudinal axis of the rod, to a third depth which is different from the first depth and from the second depth.

In order to form angles between two successive cutting lips which are all different, a second angle, different from the first angle and different from 360° minus twice the first angle, is chosen. Thus a cross section of the resulting instrument is substantially triangular in shape (in the form of a triangle passing through the vertices of the cutting lips), while not being isosceles or equilateral, having no axis of symmetry and having no center of symmetry.

### BRIEF DESCRIPTION OF THE SEVERAL VIEWS OF THE DRAWINGS

The invention will be more fully understood and other characteristics and advantages of the invention will appear in the light of the following description of an example of embodiment of an instrument according to the invention. This example is given on a non-limiting basis. The description is to be read in relation to the attached drawings, in which:

FIG. 1 is a front view of an instrument according to the invention,

FIGS. 2a and 2b are sections A-A through the working area of the instrument of FIG. 1,

FIGS. 3a and 4a are, respectively, a front view and a section B-B through the working area,

FIGS. 3b and 4b are, respectively, a front view and a section B-B through the working area, offset (by rotating the instrument about its longitudinal axis) by a first angle with respect to FIGS. 3a and 4a,

FIGS. 3c and 4c are, respectively, a front view and a section B-B through the working area, offset by a second angle with respect to FIGS. 3b and 4b.

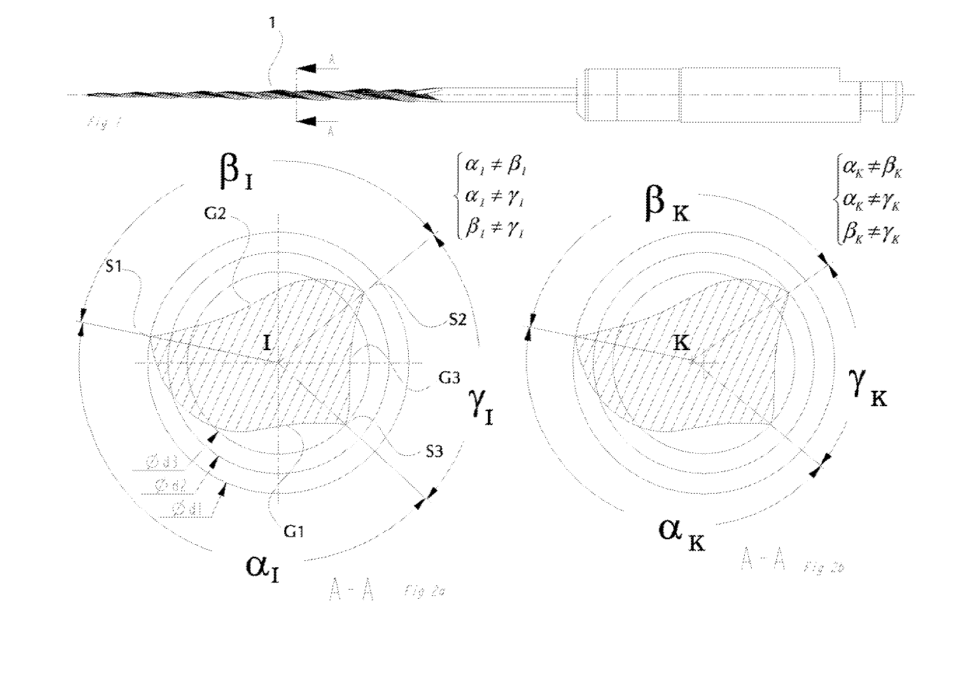

### DETAILED DESCRIPTION OF THE INVENTION

As stated above, the invention relates to a root canal instrument of the dental reamer type, having a substantially cylindrical or conical working area 1 along a longitudinal axis, that is to say the longitudinal axis of the cylindrical or conical rod from which the instrument is cut. The longitudinal axis is straight.

In the illustrated example, the instrument comprises X=3 helical flutes G1, G2, G3, forming X=3 helical cutting lips S1, S2, S3, each cutting lip being formed by the intersection of two successive flutes. In the illustrated example, the instrument also comprises a sleeve adapted to fix the instrument in an instrument holder such as a handpiece or a contra angle handpiece.

According to the invention, in a cross section of the instrument (see section A-A or B-B), in a plane perpendicular to the longitudinal axis of the instrument, the angles between αI, βI, γI between two successive cutting lips, measured with respect to the longitudinal axis (point I, the intersection between a cross section and the longitudinal axis), are all different.

Also in the illustrated example, the angles αK, βK, γK between two successive cutting lips, measured with respect to a center of gravity K of the cross section, are all different. Thus, by contrast with the prior art instruments, the triangle whose vertices pass through the lips S1, S2, S3 is neither equilateral nor isosceles; more precisely, this triangle has no axis of symmetry and no center of symmetry.

It should be noted that, in FIGS. 2a, 2b, the same section A-A is shown twice, simply in order to show more clearly the angles αI, βI, γI between two successive cutting lips, measured with respect to the longitudinal axis, and, on the other hand, the angles αK, βK, γK between two successive cutting lips measured with respect to a center of gravity K of the cross section.

It should be noted that, for the instruments according to the invention, the center of gravity K of a cross section is offset with respect to the longitudinal axis of the instrument, because of the special shape of the cross section. The center of gravity K of each cross section is located on a helical curve.

Also in the illustrated example, the angles between the cutting lips αI, βI, γI with respect to the longitudinal axis, or αK, βK, γK with respect to the center of gravity K of the cross section, are different from each other, but are constant over all sections of the working area and over the whole length of the working area. By way of example, an angle αI or αK of the order of 140 to 180 degrees, an angle βI, βK of the order of 120 to 160 degrees, and an angle γI or γK of the order of 20 to 100 degrees provide an instrument which is particularly effective for preparing a root canal while screwing or engaging in the canal wall to the smallest possible extent.

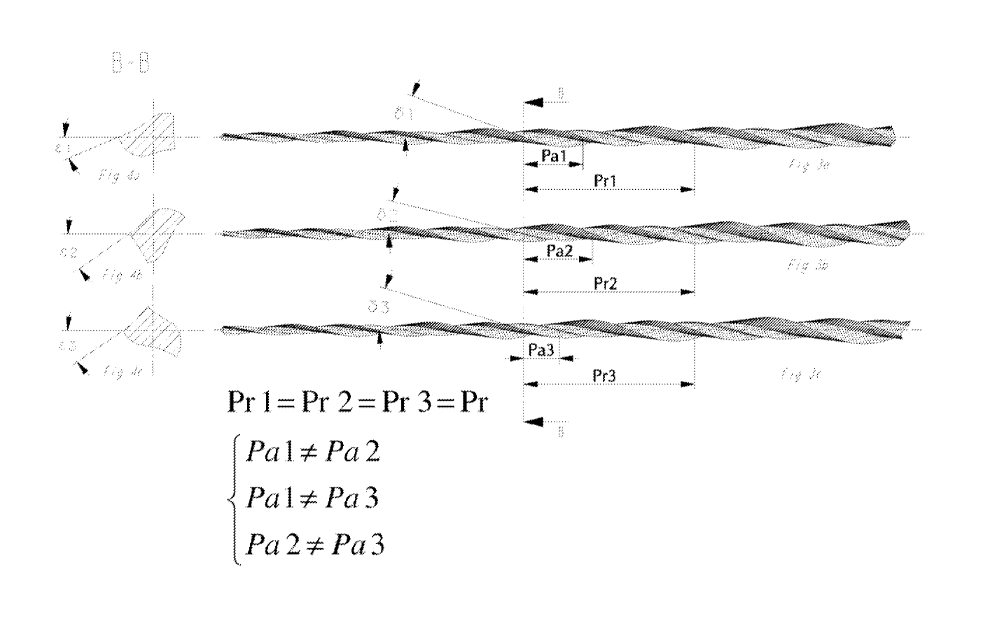

The actual pitch Pr1, Pr2, Pr3 of a cutting lip is the axial distance between two homologous profiles of a single cutting lip, that is to say the projection on the longitudinal axis of the distance covered by moving along a cutting lip through an angle of 360°. The actual pitches of all the cutting lips S1, S2, S3 respectively are identical: Pr1=Pr2=Pr3=Pr (FIGS. 3a to 3c).

The apparent pitch of a cutting lip is the axial distance between two homologous profiles of two successive cutting lips. Pa1=Pr*(αI/360); Pa2=Pr*(βI/360); Pa3=Pr*(γI/360). Since the angles αI, βI, γI between the cutting lips are all different, the apparent pitches Pa1, Pa2, Pa3 are also all different from each other.

Also, in the illustrated example, all the cutting lips are positioned on concentric circles having a center I and diameters Φd1, Φd2, Φd3 which are all different. The circles are centered on the longitudinal axis of the instrument, that is to say the longitudinal axis of the cylindrical or conical rod from which the instrument is cut.

Also in the illustrated example, in a given cross section, the helix angles δ1, δ2, δ3 are all different (FIGS. 3a to 3c). A helix angle is an angle between the longitudinal axis of the instrument and a tangent to a cutting lip, in the cross section in question.

Finally, in a given cross section (the section A-A or B-B in this case), the cutting angles are all different. A cutting angle. The reader is reminded that, for a given cutting lip, formed by the intersection of two successive flutes, the cutting angle is, in the plane of a cross section through the working area, the angle formed by the tangent to the flute located on the side of the cutting direction and a radius (perpendicular to the surface to be cut) passing through the cutting edge and the axis of the instrument (point I). In FIGS. 4a to 4c, the cutting angles are the angles ε1, ε2 and ε3.

1. A root canal instrument of the dental reamer type, having a substantially cylindrical or conical working area along a longitudinal axis of the instrument, the working area comprising X helical flutes, forming X helical cutting lips, each cutting lip being formed by the intersection of two successive flutes, where X is greater than or equal to three, the instrument being characterized in that, in a cross section of the instrument, the angles (αI, βI, γI) between two successive cutting lips, measured with respect to the longitudinal axis of the instrument, are all different.

2. The instrument as claimed in claim 1, wherein, in the cross section of the instrument, the angles (αK, βK, γK) between two successive cutting lips, measured with respect to a center of gravity (K) of the cross section, are all different.

3. The instrument as claimed in claim 1, wherein the angles between two successive cutting lips, measured with respect to the longitudinal axis of the instrument (I) or with respect to the center of gravity (K) of the cross section, are constant over a portion of the working area of the instrument.

4. The instrument as claimed in claim 1, wherein the angles between two successive cutting lips, measured with respect to the longitudinal axis of the instrument or with respect to the center of gravity of the cross section, are variable over a portion of the working area of the instrument.

5. The instrument as claimed in claim 1, wherein the cutting angles of the cutting lips axe all different.

6. The instrument as claimed in claim 1, wherein the helix angles in the same cross section are all different.

7. The instrument as claimed in claim 1, wherein all the cutting lips are positioned on concentric circles, centered on the longitudinal axis and all having different diameters.

8. The instrument as claimed in claim 1, comprising X=3 helical flutes.

9. A method for making a root canal instrument as claimed in claim 1, from a cylindrical or conical rod, the method comprising an alternating sequence of steps of machining by milling a flute to a predetermined depth, the predetermined depths all differing from one machining step to another, and steps of rotation of the rod under the milling machine.

10. The method as claimed in claim 9, for making an instrument with three helical flutes, the method comprising:
a first machining of a helical flute along the longitudinal axis of the rod, to a first depth,
a rotation of the rod about the longitudinal axis through a first angle,
a second machining of a helical flute along the longitudinal axis of the rod, to a second depth which is different from the first depth,
a rotation of the rod about the longitudinal axis of the instrument through a second angle,
a third machining of a helical flute along the longitudinal axis of the rod, to a third depth which is different from the first depth and from the second depth.

11. A method as claimed in claim 9, wherein the second angle is different from the first angle and is different from 360° minus twice the first angle.
